(19) United States
(12) Patent Application Publication
(10) Pub. No.: US 2006/0206833 A1
(43) Pub. Date: Sep. 14, 2006

(54) Sensory output devices

(76) Inventors: Rebecca A Capper, Ipswich (GB); Andrew J Hardwick, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/550,537

(22) PCT Filed: Mar. 31, 2004
(86) PCT No.: PCT/GB04/01359

§ 371 Date: Sep. 22, 2005

(30) Foreign Application Priority Data
Mar. 31, 2003 (GB) 0307399.6

(51) Int. Cl. G06F 3/00

(52) U.S. Cl. 715/773; 715/535; 345/156

(57) ABSTRACT

Sensory output devices such as wearable items, three dimensional objects such as pebbles, ornaments, toy characters and the like, include controls responsive to the content of SMS messages or to recognition of spoken words or phrases in a telephone conversation to provide a response such as a thermal change, vibrational or other tactile response, colour change or olfactory output. The output may be intensified in dependence upon the number of times at which a particular word, phrase or emoticon is identified, the control means learning from identity information to associate a current call with an historic personality trait to maintain or adapt the response provided by the sensory output device.

The present invention relates to sensory output devices and more particularly, but not exclusively, to such devices for use with mobile or cordless telephone messaging technology.

Cellular telephones have developed significantly in recent years as have the services which cellular network operators provide thereby. One of the more popular services is one called short messaging service (SMS) which permits cellular network users to send a short text message to other users. This service has proved extremely popular and has developed to allow the inclusion of icons indicative of emotions sometimes now referred to as “emoticons”. Such emoticons may include for example a smiling, frowning, laughing or crying face, outstretched arms (indicating a hug) and other such devices.

In further developments cellular mobile technology also permits the transmission of picture messages and multi-media messages (MMS) to suitably equipped mobile devices.

The popularity of SMS and MMS services is such that PSTN (Public switched telephony network) operators are allowing such services to be carried over the networks and fixed line telephones are now available with the capability for receiving SMS and MMS messages.

Many cordless telephones and some cellular telephones, PDA's (personal digital assistants also sometimes called palmtop personal computers (PPC's)) are now equipped with a low power radio connection capability for example low power radio communications operating to the “Bluetooth” standard. This output enables coupling between for example a mobile phone handset and a cordless headset or such a handset and a PPC to enable communication over the cellular network for access to the internet without the need to maintain alignment between IRDA ports or for physical coupling of the devices.

All of these capabilities are developing to enhance the users' entertainment and enjoyment although in some instances the use of the devices may be considered intrusive to others and potentially interruptive of the user's other activities.

In published PCT application no WO/01/88797 there is disclose a character device in the form of a toy adapted to provide voice output of scheduling information from a calendar program of a file server. The character is also arranged to adopt certain positions to indicate the kind of activity which the scheduling information is providing.

The present invention relates to sensory output devices which includes, but is not limited to, a toy such as that referenced above, wearable devices (hereinafter described) and other sensory stimulating apparatus including those capable of providing thermal, colour (or visual), olfactory and haptic stimulation. For the purpose of the description which follows all of the above may be referred to as sensory output devices or “SOD”.

According to the present invention there is provided a sensory output device including control means responsive to episodic receipt of data signals defining a source and/or an emotional representation (emoticon) to provide an output stimulus defining the received data signals and dependant thereon characterised in that the control means is responsive to each episode to modify the intensity of the response or to amend the response such that the output stimulus develops an intensity which changes to reflect perceivable characteristics of the source.

Preferably, the sensory output device comprises a data store which may be user programmable with preferred output responses to specific source related data. The data store may have a plurality of attributes associated with each source, each such attribute reflecting at least one emoticon and having an intensity value associated therewith, the intensity marker being incremented or decremented to reflect historic values of emotional representations received from the respective source.

Intensity markers may be decremented periodically if a pre-determined period of time elapses without receipt of an emotional representation from a source and the intensity value associated with any emoticon may be bounded such that a maximum intensity of response is provided.

Data signals may be derived from a cellular telephony messaging system and may be transferred to the control means either directly by receipt from a cellular telephone network or by way of a communication to a telephone handset with which the SOD has been previously paired. Low power radio signalling (for example “Bluetooth” communication), may be used to effect communication between a paired handset and the SOD.

SMS messages transmitted to a paired handset may be scanned by the control means to identify emoticons or specific words or phrases contained within a message to determine the response and intensity of response of the SOD. Where a message contains one or more emoticons for which a response is pre-defined, the immediate responsive output may be intensified to reflect a strength marker associated with the identified emoticons. Alternatively if a message contains a plurality of emoticons of similar characteristic the intensity of response may change to reflect the number of emoticons present.

The SOD may comprise a wearable element which may be adapted to provide a thermal response to a particular source and to vary the intensity of the thermal response in dependence upon identified characteristics of a received message. Such a response may be accompanied or be substituted by a vibration output and/or by a colour change and/or by an olfactory output.

In a further development the wearable element may include means to provide a constriction response such that the user feels a restriction followed by a relaxation of restriction (“hug”).

The SOD may alternatively be a three dimensional object such as a pebble or a plurality of pebbles responsive to data signals to provide a thermal, visual, vibration or olfactory response and such object may be incorporated in a wearable element such as a bracelet, necklace or other jewellery item.

In a still further alternative the SOD may be a three dimensional character (“toy”) having characteristics such as movements of one or more parts thereof, the movement of the parts being dependent upon source and/or emotional messages received or derived.

The control means may also be responsive to voice communications by way of the paired mobile device to identify particular words or phrases spoken during a conversation or received as a voice message to provide a responsive adaptation of the output of the SOD.

A sensory output device in accordance with the invention will now be described by way of example only with reference to the accompanying drawings of which:

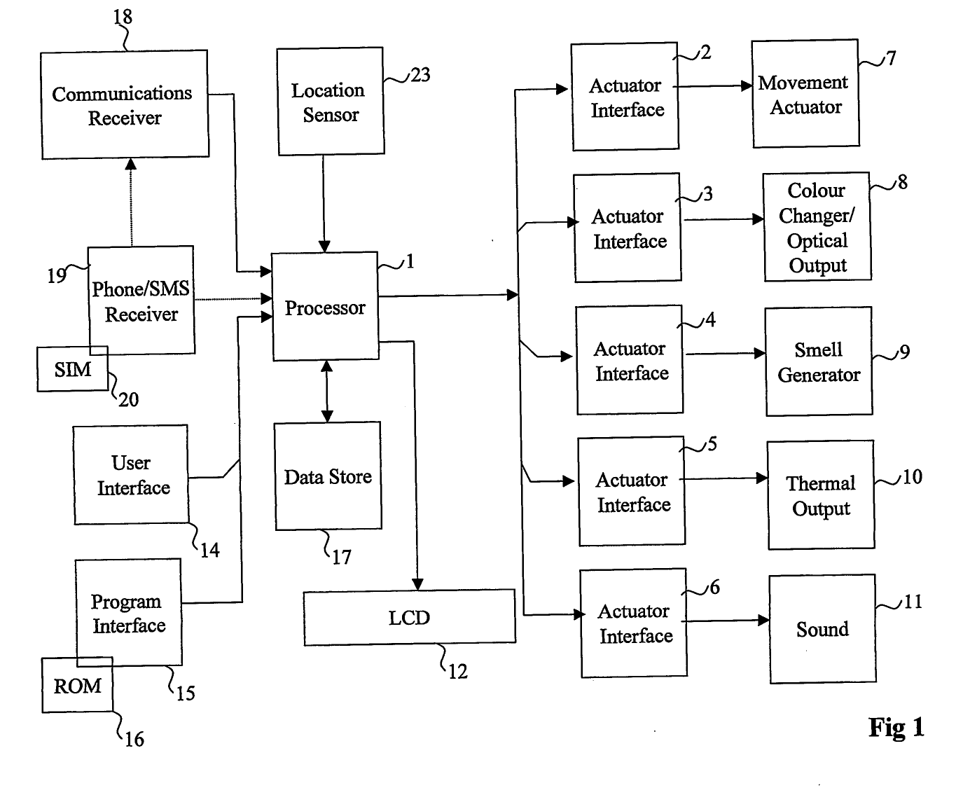

FIG. 1 is a block schematic diagram of a control circuit for a sensory output device;

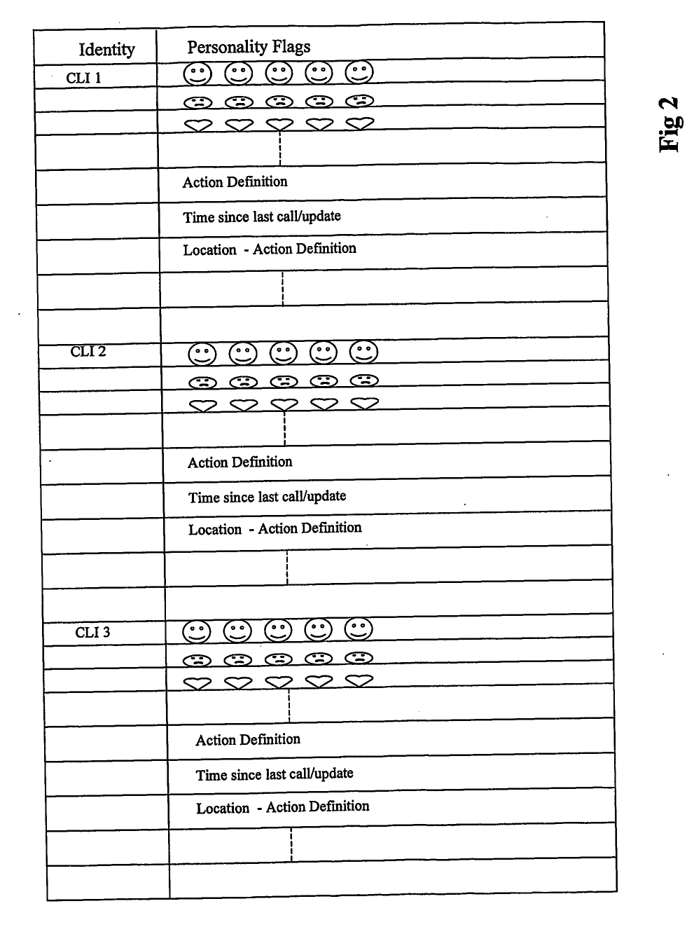

FIG. 2 is a data layout schematic used in the data store of FIG. 1

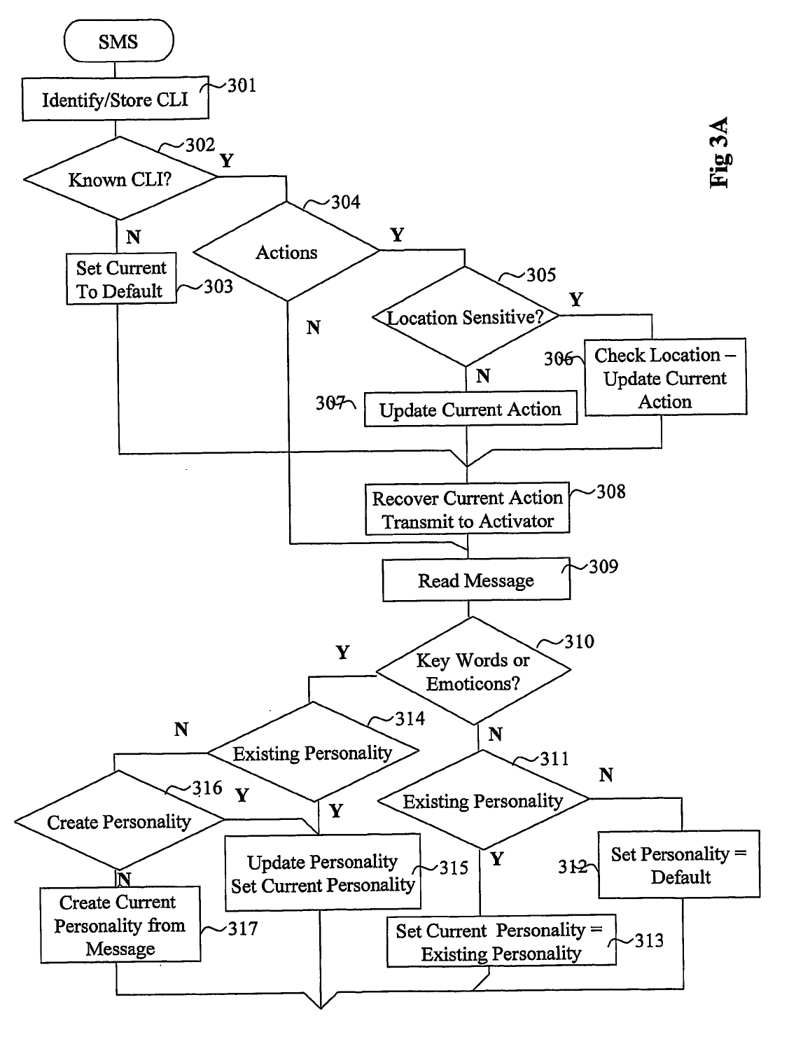

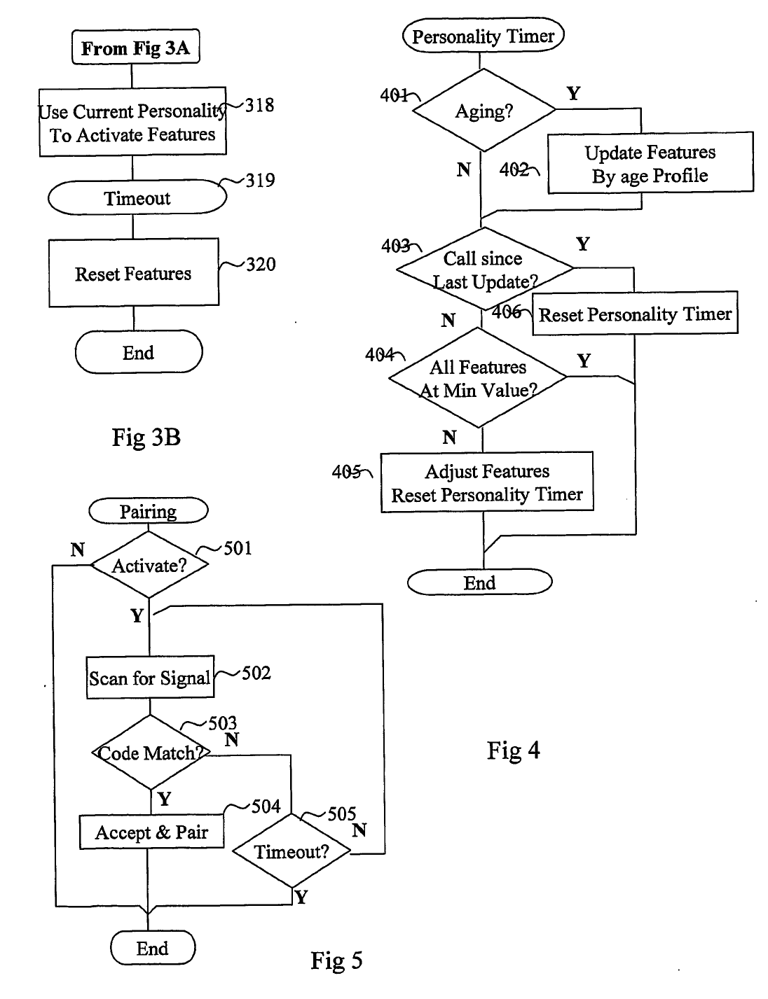

FIG. 3 A and FIG. 3 B is a flow chart of the processor of FIG. 1 when receiving an SMS or voice message;

FIG. 4 is a flow chart of the processor of FIG. 1 showing an aging process; and

FIG. 5 is a flow chart of the processor of FIG. 1 in a pairing mode.

Referring first to FIG. 1, the SOD includes a processor 1, for example a microprocessor, programmed to control at least one actuator interface within the SOD several of which 2-6 are shown for example only. Depending upon the functionality built in to the SOD there may be a number of such actuator interfaces or only a single one selected to effect actuation of a respective output function or functions.

For example, the actuator interface 2 is linked to a movement activator 7 and may cause a part of the SOD to move for example by causing constriction of one or more electro responsive bands in a wearable such as a t-shirt or sweat shirt such that if the band is incorporate between points of the material of the search on either side at the back the user may receive an apparent hug, whilst incorporating such a band in a sleeve a squeeze to the wrist or upper arm may be perceived.

In an SOD such as a three dimensional character, perhaps a toy character, the movement actuator 7 may be linked to a feature such as a waving arm or to cause the toy to move by providing motor drive for wheels or castors or other movement features. The movement actuator could also be linked to other features such as moving eyelids, mouth, and the like whereby a smile, a wink, a scowl or grimace can be provided. The movement actuator 7 might also be used to connect to a motor drive in a liquid containing bowl for example to produce a swirling effect or to generate rising bubbles in the liquid.

Other uses of the movement actuator 7 may simply include a vibrator incorporating in to a wearable or other device to produce a vibration effect perceivable by the user by feel or audibly.

The actuator interface 3 is shown as coupled to optical effect devices 8 which may produce a colour change by electro optical effect or simply provide a visual output to the user. Such an output could be combined with the movement output in a suitable environment. The actuator interface 4 is shown as being coupled to a smell generator 9 which may simply be a device preloaded with a single aerosol scent, for example a users favourite perfume or that of the users spouse whereby s sense of presence can be generated as a response to a call or SMS message.

Thermal output 10 may be provided by one of the actuator interface 5 whereby by applying electrical stimulation to a suitable coated pebble or electro responsive element a change in temperature can be provided to stimulate a user. Such could again be incorporated with other features. For completeness the actuator interface 6 is shown as coupled to an audible device 11, for example a load speaker incorporated in the toy, or wearable to provide musical, voice or similar output which may be audible to the user or may provide an atmospheric change for example by being outside the human audible range providing for example low frequency contributions to the feel of the SOD.

The SOD may include a visual display unit, for example in the form of a liquid crystal display screen to provide an output to the user or to assist with basic programming or setting up of the response required from the SOD in respect of certain received features of messages or conversations. The LCD may also be used to display the actual content of a received text message.

There may be several inputs to the processor 1 including for example a user interface such as a touch screen or connectable keyboard 14 to enable inputs in respect of required responses for example. The user interface may be as simple as a detector which senses a squeeze of a single point to enable a yes/no type response in reply to an output although more complex arrangements could be employed so that a toy for example could detect a “hug” in reply to a received message or to be transmitted in an SMS message to another user.

A program interface 15 is provided which may be designed to accept pre-programmed devices such as a read-only memory card 16 which could reflect the modus operandi of the actuators 2-6 by modifying or developing the basic programming of the processor 1.

To complete the functionality of the processor 1 there is a data store or memory which contains the required parameters of output and “personality” as determined from time to time by the operation of the processor 1.

The flexible inputs to the processor 1, those to which it is responsive to control the actuators 2 to 6 mainly comprise a communications receiver 18 which may be coupled to a message receiver such as a mobile phone, for example using the “Bluetooth” low power radio standard whereby a single receiving device, for example the mobile phone 19, may be coupled to several items. Alternatively, the SOD may incorporate a phone or SMS receiver 19 with its own SIM card whereby direct communication between a network and the SOD may be achieved although such may limit the flexibility of the SOD unless it also incorporates the LPR receiver 18.

Thus the receiver 19 may either pass data directly to the processor 1 as indicated by dashed line 21 or may forward messages using LPR as indicated by dashed line 22. In either event the response of the processor 1 is to analyse the content of the communication in order to derive actuations required and to develop the personality signature in association with the call. Over time the processor 1 will also build up an historic relationship between certain callers/message senders and a personality which can be used to modify the response of the SOD to certain callers on the basis of their historic communication pattern and content with the user.

As a further feature of the SOD a location sensor 23 may be included, for example a GPS location sensor so that the response of the SOD may be varied for different locations of the same SOD.

As an alternative to GPS positioning devices such as Radio Frequency Identity Chips (RFID) could be used whereby activation of RFID modules incorporated in the SOD and placed at strategic points could identify the location of the SOD within the confines of say a house, indicating whether the device is in a bedroom, kitche or living room for example. Thus turning also briefly to FIG. 2 the data store 1 may have a series of allocated memory positions each of which is associated with, for example, a calling line identity (CLI) which is received from the communications receiver 18. The CLI may be used to create a personality profile or to recover or update a previous personality profile to be associated with the SOD. For example, a first block of words in the data store 1 is allocated to a particular CLI (“CLI 1”) and has a number of bytes allocated to personality flags. Thus in the first three rows of the data associated with CLI 1 three typical icons (“smiley” “grumpy” and “heart”) are shown each with five allocated flags. Other icons may be used or identified and the icons shown could represent words identifiable in text messages or voice conversations rather than specific emoticons as used in SMS messaging.

There may of course be many allocated flags for differing emoticons or text words or voice words without a limitation dependent upon the available space in the memory and the number of CLI's to be specifically identified. There may also be a set of stored definitions defined as “default” values for non specific CLI's.

Also stored is an action definition which defines the responsive action which the SOD makes in respect of the differing emoticons or received elements so that these may, at the user's option, vary between callers. In its simplest form, the action definition is an actuator reference for one of the actuators 2-6 although it will be appreciated that complex actions involving performance of differing actuations in parallel or sequentially together with timing information can be provided.

To facilitate aging or adaptation of personality development over time, time and date stamp information, such as the last time a call was received or the last time an aging or de-aging process was run is also stored for subsequent use by the processor 1 to maintain some change over time of the personality of the SOD and to avoid saturation building up over a significant period without reinforcement through receipt of appropriate messages or communications.

Also shown is a location—action definition which enables the user to define alternative actions for the SOD in response to the emoticons or other words or phrases identified if it is other than at its usual location. Thus if the SOD includes a location sensor 23 then actions may be varied from place to place. Alternatively, actions could be varied on detection of a sensed orientation of the SOD. For example, voice output or actions may be varied in accordance with the location of the SOD such that in a bedroom a “sleepy” response could ensue while in an office location a more muted response might be given.

A particularly alert response could arise in a lounge or living room while a hungry response may be programmed for output in a kitchen or dining room.

In operation, the processor 1, referring now to FIG. 3, on receipt of a message first identifies the CLI part of the message (301) and compares this with all CLIs stored in the data store 17. If there is no match between the received CLI and one in the data store (302) then the “current” action is set to the default mode as stored. If, however, at step 302 a CLI is identified for which there are stored details then a check (304) is carried out to determine whether there are actions associated with the particular sender.

If there are actions associated with the user then a further check (305) as to whether the action is location sensitive is performed to determine whether the input form the location sensor will need to be taken in to account. Where location is appropriate then the location is checked 306 and the current action is updated with data recovered from the data store location-action data. If location is not a factor in the output of the SOD then the current action is set to the information contained in the primary action definition field (307).

The processor 1 will now cause the appropriate actuator(s) 2-6 to be activated (308) to indicate to the user the possible identity of the incoming caller or message sender. Note that while the description above is in respect of a received SMS message, the CLI identity process may be carried out in the same manner for a received voice or multi-media call.

Having identified the CLI and the associated data, a received SMS message text is scanned (309) to determine the presence of any emoticons or key words or phrases as identified from the stored data table. If there are no such keywords or emoticons then the CLI is used to check for the existence of a “personality” (311) which may be recovered from the icon flags previously referred to. If there is no personality for the current caller/sender then the current personality is set to the default values (312) (which may be nil). If a previous personality for the particular CLI has been developed over time then that personality is recovered and stored as the current personality (313).

Now, if at step 310 keywords, emoticons and/or phrases are identified in the message then depending upon the CLI for an existing personality as determined at 314 the associated personality profile may be updated. For example if a user profile includes two flags set for “smileys” and a further smiley is received then a third smiley flag may be set so that the output action for a friendly personality message is intensified. Such an action may be modified by the presence of “grumpies” and receipt of a smiley may result in one or more grumpies being cancelled to develop a change in the personality from each received message. Further detail may be found in the pseudo code hereinafter.

Having updated the personality the current personality is set to the values associated for use by the processor in activating the features of the SOD.

Assuming now that at step 314 the CLI is not associated with an existing personality profile in the data store, the user may be given an opportunity to create a personality profile to be associated with the CLI for future use. If this is accepted by the user then a personality will be created based upon the currently received message and/or additional user input through step 315.

If a user personality is neither present nor created then (317) a personality may be created from the latest received message. Once the current personality has been set then this is used by the processor 1 to activate 318 the features of the SOD for a predetermined period 319 prior to resetting the features for the next received message or call.

FIG. 4 shows an automated program which may run in the processor 1 from time to time to effect automated aging of the SOD or to adapt personality profiles in the data store when no adaptation has taken place for a period of time. Thus at some pre determined interval, possibly once a day or once a week for example, the personality timer program runs in the processor and determines first whether the ROM contains aging features for the SOD 401. Assuming that it does then the aging features may be applied to the profiles and/or basic activity of the SOD prior to determining whether the personalities individually of each of the associated CLIs have been updated since the last time the personality timer program ran. If there has been no updating 403 of the personality profile in the interim period then, provided all of the features are not at their minimum value 404 the features may be adjusted 405 by decrementing for example the number of flags present so that the intensity which the processor 1 applies to the actuators in respect of the particular feature is reduced. This “leaky bucket” approach ensures that the SOD does not become saturated over a period of time during which personality build up is not reset.

Finally, the personality timer is reset (405,406) to provide the time at which the program will run again.

Referring now to FIG. 5, as has been mentioned the SOD may operate in association with a mobile phone for other device communicating by Bluetooth Low Power radio. In “pairing” mode, once the user operates a pairing activation instruction the communications system 18 will scan for the presence of a transmitting bluetooth device in pairing mode (502) and will transmit an acknowledgement if one is found. Subject to then receiving the device code associated with the present SOD within a predetermined scanning period 503 it will implement acceptance and pair with the transmitting device (504) so that future communications from that device whenever it is within range may be accepted. The scanning takes place for a limited period after action, for example 2 minutes, and if no pairing signals are received in that time scanning ceases until the user again activates the pairing function.

Coinsidering a first use of an SOD (wearable device, jewellery, 3d visual output device etc), particular messages, calls or signals from a Bluetooth (BT) or low powered radio mobile phone are sent to a 3D physical product that interprets those signals and acts accordingly upon those. In this case the BT phone is sending messages to a BT 3D SOD that reacts differently to particular signals, caller ID, amount of signals and other variations in signals. These signals may be sent using sms, mms, ems and/or 3G services.

Bluetooth chips are readily available from manufacturers in bulk.

A BT mobile phone sends an sms text to a bluetooth enabled/chipped physical SOD.

The Bluetooth in the phone would talk to the bluetooth chip in the SOD (pairing as above). The SOD is normally the Bluetooth host—the master, and the mobile phone the slave. A computer can be a master and a slave which will enable the SOD to talk to the computer if necessary also.

In order to make your BT mobile phone talk to and activate your SOD and your SOD alone, they need to become a pair. The Bluetooth mobile phone and product would be paired via standard Bluetooth protocol. Once they have detected each other, you would just need to press a button or input a pin number, which will be requested on each to confirm that you wish the two to become paired. The pin number would most probably be generated uniquely and randomly on your SOD, which the user could then input into their mobile phone via it's keypad. The little screen on the SOD could be a robust but cheap and simple calculator type LCD screen on which to view the pin code.

When the phone or product are taken out of range of one another, the SOD will not be activated, but you will still receive the message on your phone which you will likely have taken with you anyway. When the phone and product return to within range of each other the auto-discover function will seamlessly and automatically pair the two together again. We believe the messages sent to the SOD whilst apart maybe lost, but will be on the phone to look at. It may be possible to resend or store them as unopened until the two re-pair and therefore you can see your SOD's responses from messages sent whilst you were away when you return. Whilst apart messages will only appear on the phone, they will not be lost. It is probably not possible to get the SOD to react to these messages at a later date.

The memory within the SOD would be mounted on a removable cartridge or card to be replaced/upgraded or to transfer the information elsewhere eg: to other compatible SODs. The memory can be sold in small quantities on the cards initially increasing over time, so that customers may upgrade to another product eg: 1 k, 5 k, 1 mb. The memory can be reprogrammable to allow you to customise your SOD or change reactions from specific messages or CLI for example.

Customisation:

The SOD may be synchronised with a desktop personal computer for example to rewrite the commands and preconfigured messages. Users could down load additional software including actions/emoticons/MMS pictures/icons and upgrades from a website to perform certain actions and customise the product. These could be customised through email via Bluetooth also.

Alternatively, the SOD may incorporate a WiFi chip permitting its use with a wireless LAN in the home. This latter usage with LAN or Broadband connection to the SOD could enable a user to have an SOD in a lounge where a computer screen may not be appropriate or desirable, the SOD responding to the receipt of e-mail messages or calendar reminders and other alerts received by the PC so that the user becomes aware of the need to view the computer output screen.

Custom applications could be written using Java to convert information between the Bluetooth chip and alter the product's outputs. Phones that support Java applications could have an extra program downloaded into them enabling them to perform more complex message sorting. Hanging onto messages until the SOD is in range for instance Interface:

The basic LCD (calculator) screen on the SOD for viewing the pin number could also be used to scroll up and down for emoticons/prefigured messages or those already stored in the mobile phone, and then you could press a send button to simply reply to any messages just received/the last message sent, that way there would be no need to have names and numbers stored, although this could be done on the memory card. This however would make the phone more redundant although it could still send the messages from the SOD through the phone via bluetooth. Alternatively it would mean the SOD would turn into a mobile phone itself in essence.

Once the mobile signal has been sent to the SOD, the mobile chip in the product would talk to the CPU (Central Processing Unit which could be flashable) The CPU may be from the Philips 8051 family, this has external program memory which can be a variety of standard memory chips, and this chip would be the removable part.

Once the CPU has received info from the mobile chip, it will compare this info with the memory in a look up table as per the following example:

This is a basic version of the program without learning, multiple emoticon messages or CLI but with reply sending.

It assumes that there is a look-up table of emoticons & actions in non-volatile memory (this can fixed at the factory, on removable media, changeable over Bluetooth etc. depending on the sophistication of the SOD), that the SOD has an LCD display which can display a number or a menu selection and there is a little bit of non-volatile memory to store the Bluetooth pairing details.

The entries in the look-up table each consist of an emoticon and an action. Emoticons with variable intensity parameters are simply treated as a set of separate emoticons (this is slightly inefficient in memory use but enables actions to be totally different, not just different in degree, for different intensities if desired). An action specified as a set signals to send to particular actuators at particular times (relative to the start of the action). Actions elements do not automatically end unless; a time bounded action needs separate action elements with later times telling the actuators to cease.

The selection is chosen by ‘Up’, ‘Down’ & ‘Okay’ buttons. The menu items include disconnecting from the particular telephone which it is currently paired with and a collection of message replies.

The program is as follows:

```
{ Call Set-up routine.
  Repeatedly do
  { If Performing Action Flag is ‘no’, do
  { If Incoming Message Count is not zero, do
    { Instruct the telephone to give out the message text.
    Receive the message from the telephone.
    For each entry in the Emoticon & Action Table, do
    { If the message text equals the emoticon in that table entry
      { Set Performing Action Number to entry's index number
      in the table.
      Instruct the telephone to give out the sender's telephone number.
      Receive the telephone number from the telephone.
      Set Reply To Number to that telephone number.
      Instruct telephone to delete the message.
      Set Performance Clock to zero.
      Set Performing Action Flag to ‘yes’.
      Break out of this search through the Emoticon & Action Table.}}
    Decrement Incoming Message Count.}}
  If Time To Next Pairing Test >= some chosen constant, do
    { Test the Bluetooth link to the telephone.
    If the test failed, do
    { Call Clear-up routine.
      Restart the program.}
    Set Time To Next Pairing Test to zero.}
    Do autonomous actions (if the particular SOD requires it).}}
  Set-up routine is
  { Set Incoming Message Count to zero.
  Set Selected Menu Item to zero.
  Set Time To Next Pairing Test to zero.
  Set Reply To Number to something that is not a valid
  telephone number.
  Set Performing Action Flag to ‘no’.
  If there is not a Bluetooth pairing to a telephone.
  { Create a Bluetooth pairing to the telephone in the standard way.}
  Enable Clock Interrupt.
  Enable Selector Interrupt.
  Enable Bluetooth Interrupt.
  Instruct the telephone to notify SOD of received messages.}
  Clear-up routine is
  { Disenable Bluetooth Interrupt.
  Disenable Selector Interrupt.
  Disenable Clock Interrupt.
  Break Bluetooth pairing to telephone.}
  Clock Interrupt handler is
  { Suspend Clock Interrupt.
    If the is a valid Emoticon & Action Table index, do
    { Set Performing Action Flag to ‘no’.
    Look up Performing Action Number th entry in Emoticon &
    Action Table
    For each element in that action, do
    { If the Performance Clock = the time for that action, do
      { Output specified signal for that action to the specified actuator.}
      If the Performance Clock < the time for that action, do
    { Set Performing Action Flag to ‘yes’.}}
    Increment Performance Clock.}
  Decrement Time To Next Pairing Test;
  Enable Clock Interrupt.}
Menu Interrupt handler is
{ Suspend Menu Interrupt.
  If button pressed was the Up button, do
  { Increment Selected Menu Item.}
  If button pressed was the Down button, do
  { Decrement Selected Menu Item.}
  If button pressed was the OK button, do
  { If Selected Menu Item is to disconnect from the telephone, do
  { Call Clear-up routine.
    Restart the program.}
  If Selected Menu Item is to reply to the previous message, do
  { If there is a Bluetooth pairing and the Reply To Number is valid, do
    { Instruct the telephone to create a message.
    Pass the Selected Menu Item's message (emoticon) to the telephone.
    Pass the Reply To Number to the telephone.
    Instruct the telephone to send the message.}}}
  Display text for Selected Menu Item on the LCD.
  Resume Menu Interrupt.}
Bluetooth Interrupt handler is
{ Suspend Bluetooth Interrupt.
  If the Bluetooth message notifies of a received SMS message, do
  { Increment Incoming Message Count.}
  Resume Bluetooth Interrupt.}
```

Pseudocode for SMS SOD with Learning

The following features may be provided by an SOD in accordance with the invention although the list below is not intended to be exclusive of other activities.

Performing actions in response to incoming messages.

Incoming messages via Bluetooth link with a mobile telephone.

Bluetooth pairing set-up when commanded.

Bluetooth link automatic reconnecting on power up.

Bluetooth link automatic reconnecting when coming back within range.

Bluetooth pairing breaking when commanded.

Recovery from power failure & other causes of rebooting.

Queues messages which arrive whilst actions are being performed.

Action can be time-bounded or open ended.

Reply message to previous message sender when commanded.

Automatic telephone command disenabling if the link is broken.

Three button & LCD menu command input.

Menu input multitasks with action performing.

SOD actuators reset to predefined initial (i.e. “off”) state upon power-up.

Caller-specific actions.

Learning (or simulated learning).

Several features of the program are not to meet functional requirements but optimisations for running on a micro controller (e.g. using interrupts rather than poling and keeping the call-stack small) for robustness (e.g. it can cope with new messages arriving whilst it is still performing the actions from previous ones & will recover from power failures).

Hardware:

It assumes that there are look-up tables of emoticons & actions in ROM or non-volatile RAM (this can fixed at the factory, on removable media, changeable over Bluetooth etc. depending on the sophistication of the SOD), that the SOD has an LCD display which can display a number or a menu selection and there is a little bit of non-volatile RAM to store the Bluetooth pairing details. If caller-specific actions are required then the emoticon look-up table also needs to be in non-volatile RAM or replicable writable ROM.

EEPROM would typically be used as the non-volatile RAM, in which case the direct use of use of the data in it in the following program would probably, at a low level, be replaced with commands to read from & write to the EEPROM but the algorithm would otherwise be the same.

Menu:

The selection is choosable by ‘Up’, ‘Down’ & ‘Okay’ buttons.

The menu items include pairing to a Bluetooth telephone & breaking the current pairing which are done by choosing the item from the menu and pressing the ‘Okay’ button. It also includes sending a reply message which is done by choosing the emoticon to reply with from the menu and pressing ‘Okay’ whereupon it will be sent to the sender of messages which caused the most recently performed action.

Databases:

The entries in the Emoticon Table each consist of an emoticon, a caller ID (telephone number) and the number of the action (indexing into the Action Table) which is to be performed when that emoticon is received is received from that particular telephone number. To specify a default action for a particular emoticon (for use if it is received from a telephone number for which there is not a specific entry for that emoticon), simply specify the telephone number as null. All such default (null telephone number) entries should be after the specific telephone number entries in the table with the same emoticon so that the specific ones are found first in searches.

Emoticons with variable intensity parameters are simply treated as sets of separate emoticons in the Emoticon Table (this is slightly inefficient in memory use but enables actions to be totally different, not just different in degree, for different intensities if desired and makes the program simpler).

The entries in the Action Table specify as a set action elements, each of which consists of the signal to an actuator, the label of which particular actuator to send it to and what time times (relative to the start of the action) to send it. Actions elements do not automatically end. If a time bounded action is required then it can be made of two separate action elements with different times, the former being a ‘start’ signal to an actuator & the latter being a ‘stop’ signal. The Action Table includes entries for all the actions referenced from the Emoticon Table & the Caller-specific Emoticon table plus an extra one to be performed on power-up (typically turning all the motors off).

Learning:

The program is initially presented without any learning ability but with place-holder functions for the learning (or simulated learning) features. It is then followed by a set of replacement routines for exemplifying some simple learning algorithms. These could be combined (e.g. logarithmic stages based on incoming message numbers, frequencies & content per telephone number) and/or replaced with further learning algorithms.

Of course, if a particular learning routine modifies the Emoticon Table or Action Table then that table must be in non-volatile RAM or EEPROM not ROM.

Similarly, the Age record and any history call records used for the learning routine must be stored in it. The Age record is set to zero when the SOD is manufactured.

```
Program is
{ Call Power-up routine.
  Call Set-up routine.
  Repeatedly do
{ Test the Bluetooth link to the telephone.
  If the test passed, do
  { While Time Since Pairing Test < some chosen constant, repeatedly do
  { If Performing Action Flag is ‘no’, do
    { If Incoming Message Count is not zero, do
    { Instruct the telephone to give out the message text.
      Receive the message from the telephone.
      Instruct the telephone to give out sender's telephone number.
      Receive the telephone number from the telephone.
      For each entry in the Emoticon Table, do
      { If the message text equals the that entry's emoticon
      { If the telephone number matches the received one or is null
        { Set Performing Action Number to that entry's emoticon.
        Set Reply To Number to that telephone number.
        Instruct telephone to delete the message.
        Set Performance Clock to zero.
        Set Performing Action Flag to ‘yes’.
        Call Learn From Received Message routine.
        Break out of this search through the Emoticon Table.}}
      Decrement Incoming Message Count by one.}}}
  Do autonomous actions (if the particular SOD requires it).
  Set Time Since Pairing Test to zero.}
  Otherwise
  { Call Clear-up routine.
  Call Set-up routine.}}
Power-up routine is
{ Set Performing Action Number to the power-up action's number.
  Set Performing Action Flag to ‘yes’.}
Set-up routine is
{ Set Incoming Message Count to zero.
  Set Selected Menu Item to zero.
  Set Time Since Pairing Test to the maximum value the variable can take.
  Set Reply To Number to something that is not a valid telephone number.
  If there is not a Bluetooth pairing to a telephone.
  { Create a Bluetooth pairing to the telephone in the standard way.}
  Enable Clock Interrupt.
  Enable Selector Interrupt.
  Enable Bluetooth Interrupt.
  Instruct the telephone to notify SOD of received messages.}
Clear-up routine is
{ Disenable Bluetooth Interrupt.
  Disenable Selector Interrupt.
  Disenable Clock Interrupt.}
Clock Interrupt handler is
{ Suspend Clock Interrupt.
  If the is a valid Emoticon & Action Table index, do
  { Set Performing Action Flag to ‘no’.
    Look up entry in the Action Table indexed by the Performing
    Action Number
    For each action element in that entry, do
    { If the Performance Clock = the time for that action, do
    { Output specified signal for that action to the specified actuator.}
    If the Performance Clock < the time for that action, do
    { Set Performing Action Flag to ‘yes’.}}
    Increment Performance Clock by one unit.}
  Increment Time Since Pairing Test by one unit.
  Increment Age by one unit.
  Enable Clock Interrupt.}
  Menu Interrupt handler is
  { Suspend Menu Interrupt.
  If button pressed was the Up button, do
  { Increment Selected Menu Item by one.}
  If button pressed was the Down button, do
  { Decrement Selected Menu Item by one.}
  If button pressed was the OK button, do
  { If Selected Menu Item is to disconnect from the telephone, do
    { If there is a Bluetooth pairing, do
    { Instruct the telephone to notify SOD of received messages.}
      Break Bluetooth pairing to telephone.
      Call Clear-up routine.
      Restart the program.}
    Otherwise
    { Display error message / apology.}}
  If Selected Menu Item is to reply to the previous message, do
  { If there is a Bluetooth pairing and the Reply To Number is valid, do
    { Instruct the telephone to create a message.
    Pass the Selected Menu Item's message (emoticon) to the telephone.
    Pass the Reply To Number to the telephone.
    Instruct the telephone to send the message.
    Call Learn From Sent Message routine.}}
    Otherwise
    { Display error message / apology.}}
  Display text for Selected Menu Item on the LCD.
  Resume Menu Interrupt.}
Bluetooth Interrupt handler is
{ Suspend Bluetooth Interrupt.
  If the Bluetooth message notifies of a received SMS message, do
  { Increment Incoming Message Count by one.}
  Resume Bluetooth Interrupt.}
Learn From Received Message routine is
{ }
Learn From Sent Message routine is
{ }
```

### LEARNING EXAMPLE 1

### By SOD Age

This is not technically learning but will appear to be so to most users. It simply changes the behaviour with time. It does so by changing the indexing from the Emoticon Table to the Action Table based on the SOD's age.

The following example is for a SOD with 3 emoticons whose action changes with time (there could be other fixed ones) & 5 stages through which actions change (after which they stay at the final one). It requires Aging Rate to be set to the time between changes & for the Action Table to contain five entries for each of those emoticons at positions 0 to 4, to 9 & 10 to 14 respectively.

```
Learn From Received Message routine is
{ Set Life Stage equal to Age divided by Aging Rate.
  Round down Life Stage to nearest integer.
  If Life Stage > 4
  { Set Life Stage to 4.}
  Set action number in Emoticon Table for ‘:-)’ to Life Stage.
  Set action number in Emoticon Table for ‘:-(’ to Life Stage + 5.
  Set action number in Emoticon Table for ‘rm −r /*’ to Life Stage + 10.}
```

### LEARNING EXAMPLE 2

### By SOD Age, with Slowing Aging Rate

It is probably beneficial to have having the initial changes occurring relatively rapidly to encourage initial use but then slowing to save some changes for heavy, enthusiastic & long term users.

This can simply be done by having Life Stage as a non-linear function of Age with negative second differential. A logarithm is an obvious one (for a micro controller this is rather computationally intensive so a simple set of comparison to fixed numbers at increasing intervals would probably be a better implementation than mathematically calculating logs).

### LEARNING EXAMPLE 3

### By SOD Age, Alternative Method

This has the same effect as Learning Example 1 but works by modifying the Action Table instead of the Emoticon Table. The Emoticon Table is fixed & the Action Table does not have multiple entries for each Emoticon Table entry but there is third fixed table, the Life Stages Table, which is contains the set of actions to be performed for each index from the Emoticon Table at each stage of the SOD's life.

```
Learn From Received Message routine is
{ Set Life Stage equal to Age divided by Aging Rate.
  Round down Life Stage to nearest integer.
  If Life Stage > 4
  { Set Life Stage to 4.}
  For each emoticon whose action changes with SOD age, do
  { Look up the number for its action in the Emoticon Table.
  Look up action set for that action number & Life Stage in Life
  Stages Table
  Set entry in Action Table for that number to that action set.}}
```

### LEARNING EXAMPLE 4

### By SOD Age, Gradual Change in Amplitude

Learning Examples 1 to 3 have abrupt (discrete) changes in the behaviour of the SOD.

This example has a gradual change instead, for example from a small motion to a big motion.

It uses the method of Learning Example 3, changing the Action Table, but instead of looking up actions, it calculates actions. This is done by interpolating between the actions for a new SOD, specified in Young Action Table, and those for an old SOD, specified in Elderly Action Table. The action entries for each action in the Young Action table must be in the same order, of the same number & linearly combinable with the corresponding ones in the Elderly Action Table (of course). Maximum Age is fixed at the age at which the SOD should exhibit its final behaviour.

```
Learn From Received Message routine is
{ Set Life Fraction equal to Age divided by Maximum Age.
  If Life Fraction >= 1
  { Set Life Fraction to 1.}
  For each emoticon whose action changes with SOD age, do
  { Look up the number for its action in the Emoticon Table.
      Look up the action set indexed by that number in the Young
      Action Table.
  Set entry in Action Table for that number to that action set.
      Look up the action set indexed by that number in the Elderly
      Action Table.
      For each action element in the action set from the Elderly Action
      Table, do
  { Subtract from it the corresponding one from the Young Action Table.
  Multiply it by the Life Fraction.
  Add to it the corresponding one from the Young Action Table.}
  Add to the Action Table entry for that action number that action set.}}
```

### LEARNING EXAMPLE 5

### By SOD Age, Gradual Change in Action Type

The method in Learning Example 4 can also be used to have the action gradually change in type, e.g. from a motion to a sound. This can be achieved by having a Young Action Table entry containing a large amplitude motion action element and a zero amplitude sound action element (but still in the table even though it is zero) and corresponding Elderly Action Table entry containing a zero amplitude motion action element and a large amplitude sound action element. The motion component of the action would then fade out over time whilst the sound element fades in.

### LEARNING EXAMPLE 6

### By SOD Age, Gradual Change in Action Duration

Furthermore, the method in Learning Example 4 can also be used to have an action gradually change in duration, e.g. from a short light flash to a long light flash. This can be achieved by having a Young Action Table entry containing a start action element and an end action element for particular actuator and having the same action elements in the Elderly Action Table but with the time form the end action element set to a later time.

### LEARNING EXAMPLE 7

### By Total Number of Messages

Instead of simply using the age of the SOD, the SOD's behaviour can be determined by the messages it receives. In this simple example, it uses the total number of messages. For clarity, this is based on the elementary Learning Example 1 although the extra complexity of Learning examples 2 to 6 (Action Table changing, gradual changes, etc.) could, of course, be incorporated. It requires Lifetime Message Count to be stored in non-volatile RAM and to be initialised to zero at the time of manufacture. Maximum Message Count is fixed at the count at which the SOD should exhibit its final behaviour.

```
Learn From Received Message routine is
{ If Lifetime Message Count < Maximum Message Count
  { Increment Lifetime Message Count by one.}
  Set Life Stage to Maximum Message Count times 5.
  Divide Life Stage by (Lifetime Message Count + 1).
  Round down Life Stage to nearest integer.
  Set action number in Emoticon Table for ‘:-)’ to Life Stage.
  Set action number in Emoticon Table for ‘:-(’ to Life Stage + 5.
  Set action number in Emoticon Table for ‘rm −r /*’ to Life Stage + 10.}
```

### LEARNING EXAMPLE 8

### By Frequency of Messages

This example is like Learning Example 7 but, instead of using the total number of messages ever received, it uses the number of messages received recently as a measure of activity.

It could be implemented by keeping a list of times of recently received messages, removing old ones from the list, adding new ones in and counting how many are currently in the list but this example uses the simpler, but functionally similar, method of just keeping a count decaying it exponentially with time. It requires Message Activity & Previous Age to be stored in non-volatile RAM and to be initialised to zero at the time of manufacture.

Message Activity Limit is fixed at the count at which the SOD should exhibit its final behaviour. Forgetting Rate is fixed at the time constant at which remembrance of messages having arrived decays.

```
Learn From Received Message routine is
{ Set Time Since Previous Message to Previous Age minus Age.
  Set Previous Age to Age.
  Set Decay Factor to Time Since Previous Message divided by
  Forgetting Rate
  If Decay Factor is not zero
  { Divide Message Activity by exp(Decay Factor negated).}
  Increment Message Activity by one.
  If Message Activity > Message Activity Limit
  { Set Message Activity to Message Activity Limit.}
  Set Life Stage to Message Activity times 5.
  Divide Life Stage by (Message Activity Limit + 1).
  Round down Life Stage to nearest integer.
  Set action number in Emoticon Table for ‘:-)’ to Life Stage.
  Set action number in Emoticon Table for ‘:-(’ to Life Stage + 5.
  Set action number in Emoticon Table for ‘rm −r /*’ to Life Stage + 10.}
```

### LEARNING EXAMPLE 9

### By Frequency of Messages, With Caller Identification

This example is like Learning Example 7 but it works on a per-caller basis so that, for example, a message from a frequent caller can give a different action to that from an infrequent caller.

It requires Message Activity Table & Previous Age to be stored in non-volatile RAM and to be initialised to zero at the time of manufacture.

Message Activity Limit is fixed at the count at which the SOD should exhibit its final behaviour. For simplicity, sender-specific behaviour will not be shown in further examples although it could, of course, but in similarly and could be beneficial.

```
Learn From Received Message routine is
{ Set Time Since Previous Message to Previous Age minus Age.
  Set Previous Age to Age.
  Set Decay Factor to Time Since Previous Message divided by
  Forgetting Rate
  If Decay Factor is not zero
  { For each entry in Message Activity Table, do
  { Divide its message activity by exp(Decay Factor negated).}}
  Look up the Message Activity Table entry for current sender
  telephone number
  If an entry was not found
  { If the Message Activity Table is full
  { Delete entry with lowest message activity
    Reset the Emoticon Tables entries for its telephone number
    to defaults.}
  An entry for current sender telephone number with zero activity.}}
  Increment its message activity by one.
  If its message activity > Message Activity Limit
  { Set its message activity to Message Activity Limit.}
  For each entry in Message Activity Table
  { Set Life Stage to its message activity times 5.
  Divide Life Stage by (Message Activity Limit + 1).
  Round down Life Stage to nearest integer.
  For each Emoticon Table entry with telephone number matching its
  one, do
  { Set action number in Emoticon Table for ‘:-)’ to Life Stage.
    Set action number in Emoticon Table for ‘:-(’ to Life Stage + 5.
    Set action number in Emoticon Table for ‘rm −r /*’ to Life
    Stage + 10.}}}
```

### LEARNING EXAMPLE 10

### By Content of Received Messages

This example is like Learning Example 7 but, instead of using the number of messages ever received, it uses the ratio of messages of different types. In this simple example, the SOD has a mood and which is determined by the ratio of happy to sad messages received.

It requires Happy Count & Sad Count to be stored in non-volatile RAM and to be initialised to zero at the time of manufacture. Count Limit is a fixed level at which the counts are decimated to prevent overflows.

```
Learn From Received Message routine is
{ If the received message was ‘:-)’
  { Increment Happy Count by 1.}
  If the received message was ‘:-(’
  { Increment Sad Count by 1.}
  If Happy Count > Count Limit or Sad Count > Count Limit
  { Divide Happy Count by 2.
  Divide Sad Count by 2.}
  If Happy Count divided Sad Count is < 0.5
  { Set Mood Number to 0.}
  Otherwise, if Happy Count divided Sad Count is > 2
  { Set Mood Number to 2.}
  Otherwise
  { Set Mood Number to 1.}
  Set action number in Emoticon Table for ‘:-)’ to Mood Number.
  Set action number in Emoticon Table for ‘:-(’ to Mood Number + 5.
  Set action number in Emoticon Table for ‘rm −r /*’ to Mood
  Number + 10.}
```

### LEARNING EXAMPLE 11

### By Content of Sent Messages

This example is like Learning Example 11 but, instead of using the content of messages received, it uses the content of messages sent which might be a better indicator of the mood of the user. It requires Happy Count & Sad Count to be stored in non-volatile RAM and to be initialised to zero at the time of manufacture. Count Limit is a fixed level at which the counts are decimated to prevent overflows.

```
Learn From Sent Message routine is
{ If the sent message was ‘:-)’
  { Increment Happy Count by 1.}
  If the received message was ‘:-(’
  { Increment Sad Count by 1.}
  If Happy Count > Count Limit or Sad Count > Count Limit
  { Divide Happy Count by 2.
  Divide Sad Count by 2.}
  If Happy Count divided Sad Count is < 0.5
  { Set Mood Number to 0.}
  Otherwise, if Happy Count divided Sad Count is > 2
  { Set Mood Number to 2.}
  Otherwise
  { Set Mood Number to 1.}
  Set action number in Emoticon Table for ‘:-)’ to Mood Number.
  Set action number in Emoticon Table for ‘:-(’ to Mood Number + 5.
  Set action number in Emoticon Table for ‘rm −r /*’ to Mood
  Number + 10.}
```

### LEARNING EXAMPLE 12

### By Messages Replied To

This example uses the fraction of messages replied to judge how interested the user is in the received messages and thereby set a mood. This would best be done by frequency, as in Learning Example 8, but is shown here by total count to keep the example simpler.

It requires Received Count & Sent Count to be stored in non-volatile RAM and to be initialised to zero at the time of manufacture. Count Limit is a fixed level at which the counts are decimated to prevent overflows.

```
Learn From Received Message routine is
{ Increment Received Count by 1.
  Call Learn from Message routine.}
Learn From Sent Message routine is
{ Increment Sent Count by 1.
  Call Learn from Message routine.}
Learn From Message routine is
{ If Received Count > Count Limit or Sent Count > Count Limit
  { Divide Received Count by 2.
  Divide Sent Count by 2.}
If Received Count divided Sent Count is < 0.5
{ Set Mood Number to 0.}
Otherwise, if Received Count divided Sent Count is > 2
{ Set Mood Number to 2.}
Otherwise
{ Set Mood Number to 1.}
Set action number in Emoticon Table for ‘:-)’ to Mood Number.
Set action number in Emoticon Table for ‘:-(’ to Mood Number + 5.
Set action number in Emoticon Table for ‘rm −r /1*’ to Mood
Number + 10.}
```

### LEARNING EXAMPLE 13

### By Comparing the Content of Received & Sent Messages

This example compares the messages sent by the user to those which they sent in response to. This could allow the SOD to learn about the character of the discourse.

In this simple example, happy replies to happy messages are counted as ‘happy’, happy replies to sad ones as ‘reconciling’, sad replies to sad ones as ‘sad’ and sad replies to happy ones as ‘irritated’. Of course, it could be combined with caller identification, as in Learning Example 9, so that the SOD could learn the user's feelings towards particular senders and a duplicate count kept but decaying with time, as in Learning Example 8, so that the SOD could deduce the users current mood and choose a SOD mood dependant on both the user's mood and the users attitude to the message sender.

It requires Happy Count, Reconciling Count, Irritated Count, Sad Count, and In Response to be stored in non-volatile RAM and to be initialised to zero at the time of manufacture. Count Limit is a fixed level at which the counts are decimated to prevent overflows.

Learn From Received Message routine is

```
Learn From Received Message routine is
{ Set In Response To equal to the received message.}
Learn From Sent Message routine is
{ Increment Sent Count by 1.
  Call Learn from Message routine.}
Learn From Message routine is
{ If In Response To is ‘:-)’
  { If sent message was ‘:-)’
  {  Increment Happy Count by 1.}
  If sent message was ‘:-(’
  {  Increment Irritated Count by 1.}}
  If In Response To is ‘:-(’
{ If sent message was ‘:-)’
  {  Increment Reconciling Count by 1.}
  If sent message was ‘:-(’
  {  Increment Sad Count by 1.}}
If any of the Count variables > Count Limit
{ Divide all the Count variables by 2.}
If Happy Count > all of Reconciling Count, Irritated Count & Sad Count
{ Set Mood Number to 3.}
Otherwise, if Reconciling Count > both Irritated Count & Sad Count
{ Set Mood Number to 2.}
Otherwise, if Irritated Count > Sad Count
{ Set Mood Number to 1.}
Otherwise
{ Set Mood Number to 0.}
Set action number in Emoticon Table for ‘:-)’ to Mood Number.
Set action number in Emoticon Table for ‘:-)’ to Mood Number + 5.
Set action number in Emoticon Table for ‘rm −r /*’ to Mood
Number + 10.}
```

From this pseudo code we can see that the SOD could pick up any key word commands, emoticons, mms icons, voice clips or audio watermark clips and convert these into particular actions/outputs which have either been predetermined, or reconfigured by the user to perform their chosen actions in response to chosen signals.

This leads us onto the character development and ‘growth’ of the SOD over time, as this would not necessarily be changed by time itself but would be dependent on the information sent from the phone to the SOD including numbers of messages/calls, type of information in those messages/calls and who is sending these. Initially the SOD would simply respond from a signal, but character/personality development takes this much further.

Character Development:

Personality development of the SOD could be based on cumulative responses of the moticons within the messages they receive. They could also perhaps reply to you once they have developed their own personality, performing actions on their own without prompting. The cumulative responses could work on a system such as a look up table as shown below. The content in the messages or calls could be monitored to adjust the personality. This would be easier within the sms texts initially, to pick out particular characters, icons etc. For example the more love messages or hearts you get <3 (heart on its side to form an emoticon) then it may adopt more romantic actions at certain amounts of hearts sent:

<3<3<3<3<3<3<3<3<3<3=10 hearts=starts to make the SOD's heart beat

20 hearts=heart beat becomes faster

30 hearts=heart beat at same rate, randomly sings love songs throughout the day to you

40 hearts=heart beat faster, reads you love poetry, heart lights up and flashes in time with beat

50=all the above with songs/poetry read randomly, and heart/body area warms to the touch.

These behaviors will be regular for things such as heart beat, but more random—timing devices perhaps or just reads the poetry (a simple audio clip recording—could be updated/changed in memory card slot and would therefore be customizable once again, shaping the SOD into a different personality from the same messages due to its changing output capability) at time of 40^{th} heart received. Otherwise it was stop all other actions when receiving a new one to play that one to you, and not resume until there has been a gap, or simply wait until the 50^{th} heart to be sent to activate a different behavioral action. Seemingly to exhibit actions randomly however would add to the feeling of it developing its own personality and being more of a living thing, that is shaped by the mobile phone (or comp messages) but can live and exist without it also.

There could be some aspects linked to the time you have the product, whether it is simply timed responses eg: 1 day of using the product in ‘on’ mode—no hair, 200 days—very long hair, or this could be done by the cumulative responses also, so it appears to get older rather than just develop it's personality. This is not just then a movement/sound response etc, but more of a 3 D physical change to the 3D character/SOD making it look older or simply different, perhaps even going so far as to morph into a different creature/form and so on. Tails could grow, fingernails, stomachs get bigger, or it could slowly turn a different colour over time or use or from the more messages or specific messages received.

The SOD could also do different things depending on time of day even if the message & sender are the same. E.g. not use its speaker on full volume after 3 am but emit extra smell instead.

Contents of Message:

If the product generally received happy messages or hugs, it could display cheerful characteristics eg: smiley for a SOD, glowing lights and change of colour to warm cheerful colour, change of temp to warm. This would basically function for the highest numbers of one type of emoticon or message sent over a time period or numbers of messages as shown. If the person rarely gets messages, the SOD could appear lonely and sad, wearing a frown and he could begin to talk to himself and go slowly mad, doing wacky and strange things on his own on seemingly random times. It could weigh up other elements and those who are in 2^{nd} and 3^{rd} place eg: the next most is the love emoticon so it would be happy and sometimes express romantic notions and skip across your desk. Tallying these messages received to alter a personality would be done in the memory, and therefore the personality of your SOD could be transferred to another SOD, or wearable to see how that reacted. Or another SOD with different main actions built in could exhibit the personality developments in very different ways, therefore you may wish to buy another SOD to see how your memory card affected your new SOD.

In this scenario, the SOD receives the following:

[symbol]

[symbol]

(L) (L) (L) (L)=

[symbol]

There could be different types of products sold that displayed different actions eg: A football score SOD that behaved as a footy fan when they won or lost, cheering, swearing, booing, running in a circle with arms outstretched. There could be a weather one to give you the latest weather, that put up their umbrella when there was rain due, shades when sunny etc. These 2 could be service linked SODs and could also display emotions from particular messages. The device could simply be a SOD that acted from specific messages from particular friends idenbtified by CLI or e-mail address.

There is also a possibility that the SOD could change its behaviour, development and personality over time due to:

who was sending the message/call to you—caller ID/CLI

who was calling the most/least: cumulative responses in orders to effect personality

Frequency of contact:

Cumulative responses:

Content of contact: ie: type of emoticons/icons/voice/volume/tone etc

Method of contact ie: from web sms sender or from mobile phone or landline/fixed phone. With a landline, the phone line would simply be tapped into and CLI used for example.

Time of day message was sent ie: not use its speaker on full volume after 3 am but emit extra smell instead.

Plus any combination of any of the above at one time:

In this scenario, if Anna's SOD is called by Bob the most, and Bob has been given the CLI of making Anna's SOD goblin jump, then the more times Bob sends to Anna, the more the Goblin will jump. The memory in the SOD will keep a record of this jumping every time Bob send a message, and so the goblin will begin to change it CLI reaction/behaviour/personality the more messages it receives from Bob. In this instance the goblin's jumps will get higher and higher, maybe adding a yelp as he jumps and eventually back flipping over time for example when the CLI count becomes 200. The SOD could also monitor messages sent from other callers, meaning if it received mostly calls from Bob then the SODs personality would be more skippy jumpy happy. If Anna has allotted some meaner CLI reactions (frowning and stamping it's foot) to her boss and mother in law and they start calling Anna more than Bob, then the Goblin will not only express these actions when they call, but the more calls they get the more this will add to the goblins behaviour generally, as it could also function occasionally, seemingly randomly to exhibit its developing personality out loud or visually etc. In this case, the more calls from her Boss and mother in law, the more the Goblin will frown and stamp it's feet, but will gradually become angrier and angrier. These would be dependant on the CLI reaction you allotted to your senders to begin with. For example:

Allotted CLI reaction to any contact on phone/SOD from sender:

Bob=jump

Boss=stamp feet

Mother in law=frown

The more contacts made by senders eg:

Bob=50× jump, 100× jump and yelp happily, 200× back flip, 300× back flip and says ‘yeee haa!’

Boss=50× stamp feet whilst stationary, 100× stomp across surface, 200× stomp around and shout, 300× stomp, shout and go red/hot.

This could also be adjusted if a message contained more than one emoticon/specific signal eg: [symbol] <3 [symbol] (smile heart frown). This could combine into a new or variation of a responding action, and again along with the other varying elements could produce different responses.

Intensity:

Instead of just sending an emoticon [symbol] to produce a smiley SOD or warm vest for the receiver, the sender can choose the intensity of that in the action code eg: [symbol] 5, which would be a medium smile intensity with the range running from 0-9. A [symbol] 1 being a smirk or faint heat/light for example and a [symbol] 9 being a wide smile and maybe a giggle/strong light/heat/colour change etc. For example:

[symbol] 1=smirk

[symbol] 2=smirk and one eyebrow moves u

[symbol] 3=moreofasmile

[symbol] 4=smile

[symbol] 5=wide smile

[symbol] 6=wide smile, wide eyes

[symbol] 7=wide smile, wide eyes and eyes light up

[symbol] 8=wide smile, giggle, eyes lit up and changes colour of face from pink to bright yellow.

Since the target market is mainly the youth/kids (although could be branded for any age range—eg: executive SODs), to appeal to kids and what entertains them, SODs could not only making flatulent noises but emit matching smells. Although not to tasteful, kids would love it.

Voice of the person ringing you or what they are actually saying to affect the SOD's personality.

Perhaps could be done simply at first using tone of person's voice or changing volumes/intination in voice, or ultimately using voice recognition software the SOD could decode voice messages left for example and act correspondingly to these.

Digital audio watermark technology to activate the product from the phone/comp etc.

Specific little ‘clips’ set off specific actions but from sound. SOD can listen into the conversation by the audio channel of the BT link. The senders phone could then include audio watermarks to make the SOD react in the middle of a conversation.

Download celebrity voices/effects (Gandalf from LOTR—whatever's big at the time)/record your friend's voice messages and product can speak them back to you via a voice synthesizer. Don't just download these but update these into your memory card slot to effect your SODs personality, and capabilities.

Football scores could be reconfigured and customers could subscribe to a service that not only send football scores to your phone, but that sends a win or lose to your SOD for your particular team each game. This would result in one of 2 actions by the SOD eg: A jump for joy or shake of the head and frown. We could link into this service and results could possibly be read to you by your SOD. Instead of reading every result ever sent to your phone, the SOD could do call back and read off results from your voice mailbox. You would need a big server with caller ID.

Potential for Polyphonic, though this is more a capability of the phone not the SOD.

MMS voice clips could be attached to photos or any other media and emotions sent along with this which could be displayed through the SOD? Tag photo image somehow and add emotions, smells and sound clips.

Haptic feedback of SOD or wearable eg: Anna hugs her SOD bear in London and presses ‘send’ her partner's bear in Glasgow opens it's arms for a hug and his little heart warms and glows red. It could be that the SODs could be sold in pairs—two way responsive message sending, otherwise it would work as described and it would be possible to reply to a message received by your SOD by Anna hitting reply on her SOD and then hugging her SOD. This message would be sent to her friend in Glasgow. This would be the same as choosing reply and scrolling down to hug, and hitting send, but more interactive. This method could be made easier with wearables—as below.

The bear could also change temp, vibrate and change colour or emit smell for example.

Scenario 2:

Not just toys and creatures, but clothing, jewellery, footwear and wearables:

Clothing or wearables could react mostly from messages from your friends or partner, perhaps even just your partner in a two responsive set up.

Battlebots could be set up at a remote location or at one friends house and could be messaged into action making and playing sms moves out from commands sent. You could get reports back from the robots themselves sent to your phone, or your friends could use picture messaging on their phones or a webcam to show the destruction. This could be done for games of chess also over long distances, but not just online but in 3D.

If the product generally received happy messages or hugs, it could display cheerful characteristics eg: smiley for a SOD, glowing lights and change of colour to warm cheerful colour in a wearable or clothing.

SMS services such as sports results could even be voiced by the SOD which could be incorporated in clothing such as a coat or the like which might include haptic feedback of in a wearable item eg: hug your SOD bear and the receiver's bear hugs someone at the other end constricting your t-shirt.

Wearables/clothing could constrict using a tourniquet system with loops around the chest or SMA (shape memory alloys) to form differently when heated and then return to their original shape. This could use peltier devices to heat.

Could be two way responsive to just hit ‘reply’ button, or would need LCD to select who to send to (though this would make the interface much more complex and requires tapping into the phones memory) so again just hitting reply or send would send back to the last person who sent a message or to the other half of the pair of it were 2 way responsive messaging. You could adopt the hug pose wearing the jumper with sensors on it and with your hands around your back in position could hit the send button to who ever you have already chosen to send the hug to. Sensors pick up the ‘hug’, send it to your partner wearing his vest and it will warm and gently constrict.

Secret Messaging:

Secret messaging with wearables in shoes, underwear, wrist bands that change temp or vibrate—in morse code perhaps/rhythms/bursts. Could be emotional messaging and secret or either.

Uses different interpreter and actuator. Needs on button and sensors to record morse to be sent in form chosen eg: heat/vibration etc, then way of selecting person to send to. Could be on two way responsive system, or could have small shortlist-top 5 friends to message, or the LCD scrolling screen.

In a further capability of the SOD, replay of messages, either in case they have been missed or because the user particularly enjoys the message is possible. This may be achieved either by activating a switch in the SOD, for example by squeezing a paw of a toy, or by incorporating a sensor in the SOD which would detect presence of a user in the vicinity of the SOD and would play back the last message transmitted.

1. A sensory output device including control means responsive to episodic receipt of data signals defining a source and/or an emotional representation (emoticon) to provide an output stimulus defining the received data signals and dependant thereon characterised in that the control means is responsive to each episode to modify the intensity of the response or to amend the response such that the output stimulus develops an intensity which changes to reflect perceivable characteristics of the source.

2. A sensory output device as claimed in claim 1 comprising a data store which is user programmable with preferred output responses to specific source related data.

3. A sensory output device as claimed in claim 2 in which the data store includes data defining a plurality of attributes associated with each source, each such attribute reflecting at least one emoticon and having an intensity value associated therewith, the intensity marker being incremented or decremented to reflect historic values of emotional representations received from the respective source.

4. A sensory output device as claimed in claim 3 in which the intensity markers are decremented periodically if a pre-determined period of time elapses without receipt of an emotional representation from a source.

5. A sensory output device as claimed in claim 4 in which the intensity value associated with any emoticon is bounded such that a maximum intensity of response is provided.

6. A sensory output device as claimed in claim 1 in which the data signals are derived from a cellular telephony messaging system.

7. A sensory output device as claimed in claim 6 in which the data signals are transferred to the control means directly by receipt from a cellular telephone network.

8. A sensory output device as claimed in claim 6 in which the data signals are transferred to the control means by way of a communication to a telephone handset with which the SOD has been previously paired.

9. A sensory output device as claimed in claim 8 in which the data signals are transferred using low power radio signaling to effect communication between a paired handset and the SOD.

10. A sensory output device as claimed in claim 1 in which received SMS messages are scanned by the control means to identify emoticons or specific words or phrases contained within a message to determine the response and intensity of response of the SOD.

11. A sensory output device as claimed in claim 10 in which the control means scans received messages to determine if a received message contains one or more emoticons for which a response is pre-defined, and, if so, the immediate responsive output may be intensified to reflect a strength marker associated with the identified emoticons.

12. A sensory output device as claimed in claim 10 in which the control means scans received messages to determine if a received message contains one or more emoticons for which a response is pre-defined, and, if so, determines if the message contains a plurality of emoticons of similar characteristic and the intensifies the response to reflect the number of emoticons present.

13. A sensory output device as claimed in claim 1 in which the device comprises a wearable element which may be adapted to provide a thermal response to a particular source and to vary the intensity of the thermal response in dependence upon identified characteristics of a received message.

14. A sensory output device as claimed in claim 1 in which the device comprises a wearable element which may be adapted to provide an optical response which includes a colour change capability.

15. A sensory output device as claimed in claim 1 in which the device comprises a wearable element which may be adapted to provide an olfactory response.

16. A sensory output device as claimed in claim 1 in which the device comprises a wearable element including means to cause constriction of at least a part of the wearable element.

17. A sensory output device as claimed in claim 1 in which the device comprises a wearable element including means to provide a vibrational stimulus to the wearer.

18. A sensory output device as claimed in claim 1 in which the device comprises a three dimensional object responsive to data signals to provide a thermal, visual, vibration or olfactory response.

19. A sensory output device as claimed in any one of claim 18 in which the object is incorporated in a wearable element.

20. A sensory output device as claimed in claim 1 comprising a three dimensional character having characteristics including movements of one or more parts thereof, the movement of the parts being dependent upon the source and/or emotional messages received or derived therefrom.

21. A sensory output device as claimed in claim 1 in which the control means is also be responsive to voice communications and includes voice recognition means whereby particular words or phrases spoken during a conversation or received as a voice message is used to provide a responsive output to the SOD.
